(19) United States
(12) Patent Application Publication
(10) Pub. No.: US 2024/0263023 A1
(43) Pub. Date: Aug. 8, 2024

(54) A Transparent Film-Forming Composition for Producing a Near-Infrared Shielding Coating and a Method of Producing Thereof

(71) Applicant: KRISTALBOND TECHNOLOGIES SDN BHD, Shah Alam (MY)

(72) Inventors: Chooi Yang Gan, Shah Alam (MY); Choo Ann Gan, Shah Alam (MY)

(73) Assignee: KRISTALBOND TECHNOLOGIES SDN BHD, Shah Alam (MY)

(21) Appl. No.: 18/565,325

(22) PCT Filed: May 31, 2022
(86) PCT No.: PCT/MY22/50043

§ 371 Date: Nov. 29, 2023

(30) Foreign Application Priority Data
Jun. 3, 2021 (MY) PI 2021003079

(51) Int. Cl. C09D 5/32; C08K 3/20; C08K 3/22; C09D 4/00; C09D 7/20; C09D 183/06

(52) U.S. Cl. CPC C09D 5/32; C08K 3/20; C09D 4/00; C09D 7/20; C09D 183/06; C08K 2003/2258; C08K 2201/005

(57) ABSTRACT

The present invention relates to a transparent film-forming composition for producing a near-infrared shielding coating, the composition comprising a film-forming binder comprising a primary component of a reaction product of an alkoxysilane having an epoxy group and an alkoxysilane having an amino group with an active hydrogen, an acid catalyst and a near-infrared shielding material. The present invention also relates to a near-infrared shielding coating produced using the composition aforementioned and a method for producing thereof.

### FIELD OF INVENTION

The present invention relates to a film-forming composition, particularly to a transparent film-forming composition having near-infrared shielding properties suitable for producing a near-infrared shielding coating.

### BACKGROUND OF THE INVENTION

Clear glass is the most common and conventional material for glass doors and windows in commercial buildings. Traditionally, car manufacturers have used glass as the primary material for making car windows. Despite its versatility, recently it has become desirable to substitute glass windows with windows made of plastic or polymeric resin such as polycarbonate. Polymeric windows are highly sought after owing to their substantial advantages such as low weight, high strength and easy of moulding and shaping. Like glass windows, one potential limitation to the use of polymeric windows in cars and buildings is the light transmittance therethrough, hence leading to ultraviolet and infrared radiations passing through the windows unfiltered. Detrimentally, this results in a heavy thermal load on air conditioning inside the cars and buildings, which thoroughly affects occupant comfort. In general, it is believed that the automotive and building construction industries will not switch from glass to polymeric windows unless infrared filtering equal to glass is met.

A common strategy for providing protection against ultraviolet light is to apply ultraviolet-absorber loaded plastic films or paints on the car or building windows. In addition to that, air conditioning efficiency of cars and buildings can be improved by introducing infrared-reflecting agents containing metal layers such as silver or aluminium. However, these metals are known to be chemically unstable and are susceptible to oxidative degradation, forming opaque metal oxides and sulphides if not protected. Thus, infrared reflecting layers are commonly applied only in the middle of double pane glass structures where they are protected from exposure to air and water.

A more advanced approach has been demonstrated on glass windows where the infrared-reflecting metal layer containing silver or aluminium is sandwiched between two titanium dioxide or zinc oxide layers. This approach is unsuitable for polymeric substrates as the titanium oxide containing coatings could act as only a partial ultraviolet-absorber which could cause polymeric windows coated therewith to discolour. Furthermore, titanium oxide is photocatalytic and will inflict degradation to the polymeric substrates.

Another approach known in the art of infrared filtering used on glass is the application of an infrared-reflecting oxide such as indium tin oxide to the glass substrate. Indium tin oxide is electrically conductive and generally reflects well in the infrared range with wavelengths above 1500 nm. However, indium tin oxide does not relatively reflect well in the near infrared range with wavelengths between 800 to 1500 nm. Radiation filtering in the near infrared range is particularly essential for vehicle applications to prevent the vehicle cabin from overheating. Such technology is exemplified in United States of America Patent No. U.S. Pat. No. 6,875,836B2 disclosing a transparent silicone film-forming composition comprising a reaction product of an alkoxysilane having an epoxy group and an alkoxysilane having an amino group with an active hydrogen in the presence of an acid catalyst, and a mixture of finely ground ITO cocatalyst and at least one solvent is mixed therein.

In recent years, tungsten trioxide has been substituting the use of indium tin oxide in the making of glass window coatings where indium tin oxide has failed in the attempt of providing substantial filtering of near infrared radiation. One exemplary research has concluded that tungsten trioxide nanoparticle dispersion are found to show a remarkable absorption of near infrared light while retaining an acceptable high transmittance of visible light, in which the property is highly suitable for solar control filters in automotive and architectural windows [Hiromitsu Takeda, Kenji Adachi; Near Infrared Absorption of Tungsten Oxide Nanoparticle Dispersions; Journal of the American Ceramic Society; Volume 90, Issue 12]. In fact, technologies relating to the use of tungsten oxide dispersion for absorbing near infrared radiation have been disclosed in several patent documents such as United State of America Patent No. U.S. Pat. No. 7,687,141B2 and European Patent Publication No. EP2682265A1.

It is obvious that there is a need for providing a composition for use in the production of coatings having near-infrared shielding properties which can be imparted with substantial employment of tungsten trioxide. The present invention provides such a solution.

### SUMMARY OF INVENTION

One aspect of the invention is to provide a transparent film-forming composition for producing a near-infrared shielding coating. In particular, the composition comprises a near-infrared shielding material of tungsten trioxide for imparting the near-infrared shielding and absorbing functionality.

Another aspect of the invention is to provide a near-infrared shielding coating produced from the composition abovementioned which is capable of shielding and absorbing near-infrared radiation within the region of wavelengths between 800 nm to 1000 nm.

Still, one aspect of the invention is to provide a method for producing a near-infrared shielding coating using the abovementioned composition.

At least one of the preceding objects is met, in whole or in part, in which the embodiment of the present invention describes a transparent film-forming composition for producing a near-infrared shielding coating, the composition comprising a film-forming binder comprising a primary component of a reaction product of an alkoxysilane having an epoxy group and an alkoxysilane having an amino group with an active hydrogen, an acid catalyst and a near-infrared shielding material.

In a preferred embodiment of the present invention, it is disclosed that the near-infrared shielding material used is selected from the group consisting of tungsten trioxide, antimony tin oxide, indium tin oxide, stanum oxide and stanum dioxide.

Preferably, the near-infrared shielding material used is tungsten trioxide.

Preferably, the tungsten trioxide has a particle size of less than 50 nm.

In another preferred embodiment of the present invention, it is disclosed that the tungsten trioxide is uniformly dispersed in the form of nanoparticles in a solvent.

Preferably, the solvent used for dispersing the tungsten trioxide is selected from water, alcoholic solvents, ketone ether solvents and solvents having two or more functional groups selected from the group consisting of diethylene glycol diethyl ether, propylene glycol monoethyl ether acetate and dipropylene glycol monomethyl ether propanol.

It is preferred that the film-forming binder further comprises a secondary component of silane compounds selected from tri- or dialkoxylane, monoalkoxysilane, glycidesilane or combinations of any two or more thereof.

It is preferred that the composition further comprises a mixture of additives selected from an ultraviolet-absorbing agent, an infrared-reflecting agent or infrared-absorbing agent, a dye and/or pigment, a stabilizing agent and a photo-stabilizing agent.

It is also preferred that the acid catalyst is selected from sulphuric acid, nitric acid, organophosphorus compounds and p-toluenesulfonic acid.

Further embodiment of the present invention discloses a near-infrared shielding coating produced from the composition abovementioned.

Another exemplary embodiment of the present invention describes a method for producing a near-infrared shielding coating, the method comprising the steps of preparing a film-forming binder comprising a reaction product of an alkoxysilane having an epoxy group and an alkoxysilane having an amino group with an active hydrogen with tri- or dialkoxysilane, monoalkoxysilane, and/or glycidesilane, preparing a dispersion of a near-infrared shielding material by dispersing thereof in a solvent, followed by addition of a mixture of additives thereinto, mixing the film-forming binder with the dispersion in the presence of an acid catalyst to form a transparent film-forming composition, applying the liquid mixture on a pre-treated surface of a substrate and curing the liquid mixture to form the near-infrared shielding coating. Preferably, the near-infrared shielding material is selected from the group consisting of tungsten trioxide, antimony tin oxide, indium tin oxide, stanum oxide and stanum dioxide. More preferably, the near-infrared shielding material used is tungsten oxide.

One skilled in the art will readily appreciate that the present invention is well adapted to carry out the objects and obtain the ends and advantages mentioned, as well as those inherent therein. The embodiment described herein is not intended as limitations on the scope of the invention.

### DETAILED DESCRIPTION OF THE INVENTION

Hereinafter, the invention shall be described according to the preferred embodiments of the present invention and by referring to the accompanying description and drawings. However, it is to be understood that limiting the description to the preferred embodiments of the invention is merely to facilitate discussion of the present invention and it is envisioned that those skilled in the art may devise various modifications without departing from the scope of the appended claim.

The present invention relates to a transparent film-forming composition for producing a near-infrared shielding coating and a method for producing the near-infrared shielding coating using the composition aforementioned. The term “near-infrared” generally refers to the electromagnetic radiation or light in the spectrum region with wavelengths ranging between 800 nm to 1000 nm. In the context of the present invention, the near-infrared shielding coating is capable of providing protection against radiation in the near-infrared region. It has been found by the inventors that a transparent coating of excellent near-infrared radiation shielding/absorbing characteristics can be formed from a silicon-based film-forming composition comprising a film-forming binder comprising a primary component of a reaction product of an alkoxysilane having an epoxy group and an alkoxysilane having an amino group with an active hydrogen, an acid catalyst and a near-infrared shielding material. As such, the present invention also provides a near-infrared shielding coating conveniently produced from the aforementioned which will also be described in details below.

The film-forming binder used in the present invention is a primary component of the film-forming composition comprising a reaction product of an alkoxysilane having an epoxy group and an alkoxysilane having an amino group with an active hydrogen. The alkoxysilanes used in the present invention are essentially silane coupling agents which act as an intermediary that bonds organic materials to inorganic materials in the composition. The epoxy group and amino group present in the alkoxysilanes are reactive groups that form chemical bonds with organic materials such as synthetic resins, thereby improving adhesion and mechanical strength of the film-forming binder.

The alkoxysilane having an epoxy group used in the film-forming binder may be selected from the group consisting of 2-(3,4-epoxycyclohexyl) ethyltrimethoxysilane, 3-Glycidoxypropyl methyldimethoxysilane, 3-Glycidoxypropyl trimethoxysilane, 3-Glycidoxypropyl methyldiethoxysilane and 3-Glycidoxypropyl triethoxysilane.

The alkoxysilane having an amino group with an active hydrogen used in the film-forming binder may be selected from 3-Aminopropyltrimethoxysilane, 3-Aminopropyltriethoxysilane, N—(β-aminoethyl)-3-aminopropyltrimethoxysilane and N—(β-aminoethyl)-3-aminopropyldimethoxysilane. Preferably, N—(β-aminoethyl)-3-aminopropyldimethoxysilane is used in the film-forming binder. When N—(β-aminoethyl)-3-aminopropyldimethoxysilane is used as the primary component of the film-forming binder, the resultant composition yields a hard film after curing, which is suitable as a coating for car window glass as no flaw is observed through opening and shutting of the window.

When preparing the film-forming binder with the primary component of a reaction product of an alkoxysilane having an epoxy group and an alkoxysilane having an amino group with an active hydrogen, the formulating ratio of the alkoxysilane having an epoxy group and the alkoxysilane having an amino group with an active hydrogen is preferably in the range of 1:1 to 9:1, more preferably 1:1 to 4:1 in the mass ratio. Hereinafter, the aforementioned formulation shall be referred to as Formulation I. In the preparation of Formulation I, if the mass ratio of the alkoxysilane having an epoxy group is more than 9, a longer duration of curing of the film-forming composition may be required to obtain the resultant near-infrared shielding coating. In addition, the surface hardness of the coating formed therefrom may be low. On the other hand, if the mass ratio of the alkoxysilane having an amino group with an active hydrogen is more than 4, the weather resistance of the resultant near-infrared shielding coating may be reduced.

If desired, a secondary component of silane compounds may be used in the film-forming binder to adjust surface properties of the resultant coating such as ultimate hardness, drying rate and weather resistance. According to a preferred embodiment of the present invention, the film-forming binder further comprises a second silane compounds selected from trialkoxyliane, dialkoxysilane, monoalkoxysilane, glycidesilane or combinations of any two or more thereof. In other words, the film-forming binder may be a reaction product of an alkoxysilane having an epoxy group and an alkoxysilane having an amino group with an active hydrogen with trialkoxyliane, dialkoxysilane, monoalkoxysilane, glycidesilane or combinations of any two or more thereof.

In this instance, the trialkoxysilane or dialkoxysilane used in the secondary component of the film-forming binder may typically include trimethoxymethylsilane, dimethoxydimethyl-silane, trimethoxyethylsilane, dimethoxydiethylsilane and triethoxyethylsilane. It has been confirmed that the aforementioned silane compounds improve the surface hardness of the cured coating. The monoalkoxysilane used in the secondary component of the film-forming binder may include methoxysilane, ethoxysilane, propoxysilane and butoxysilane.

In accordance to that, when preparing the film-forming binder comprising both the primary component of a reaction product of an alkoxysilane having an epoxy group and an alkoxysilane having an amino group with an active hydrogen and the secondary component of silane compounds, the formulating ratio of alkoxysilane having an amino group with an active hydrogen and the secondary component of silane compounds may be increased or decreased depending on the desired surface properties of the near-infrared shielding coating to be obtained. Hereinafter, the aforementioned formulation shall be referred to as Formulation II. In the preparation of Formulation II, the drying time may be accelerated when the ratio of the secondary component of silane compounds is increased to reduce the coating workability, however may cause cure shrinkage marks on the coating. On the other hand, an increase in the ratio of the alkoxysilane having an amino group with an active hydrogen may affect an organic functional agent to be added afterwards. Hence, it is important to polymerize the aforementioned components on the basis of equimolar ratio so as to form a weather-resistant coating and improve the hardness thereof sufficiently. It is preferred that the formulating ratio of the alkoxysilane having an epoxy group, the alkoxysilane having an amino group with an active hydrogen and the silane compounds of the secondary component may be present in the range of 8:4:1 to 8:8:5 each of which is not always an integer.

An acid catalyst is used in the film-forming composition for producing a near-infrared shielding coating. Should a hydrophilic alkoxysilane having a hydroxyl group be alternatively used, the acid catalyst functions to promote hydrolysis thereof at room temperature to form a silanol of a higher reactivity, which then facilitates condensation-polymerization of the formed silanol. According to a preferred embodiment of the present invention, the acid catalyst used may be selected from sulphuric acid, nitric acid, organophosphorus compounds and p-toluenesulfonic acid, although boron trifluoride may be considered.

As the name proposes, the film-forming composition is suitable to be used for producing a near-infrared shielding coating, in which the coating has the ability to selectively shield and absorb an electromagnetic radiation in the near-infrared region with specific wavelengths ranging between 800 nm to 1000 nm. Such ability is a unique feature of the present invention and is imparted by the inclusion of a near-infrared shielding material in the composition. Commonly used near-infrared shielding materials are metal oxides. According to a preferred embodiment of the present invention, the near-infrared shielding material is typically selected from the group consisting of tungsten trioxide, antimony tin oxide, indium tin oxide, stanum oxide and stanum dioxide. Generally, metal oxides are capable of shielding and absorbing radiations in the infrared region with wavelengths of 780 nm to 1 mm, however, tungsten trioxide is capable of shielding and absorbing near-infrared radiation within the region of wavelengths between 800 nm to 1000 nm whereby the highest intensity of infrared radiation of about 950 nm from sunlight is within the aforementioned region. Therefore in the context of the present invention, tungsten trioxide is most preferred to be used as the near-infrared shielding material in formulating the film-forming composition.

To provide sufficient functionalization of the near-infrared shielding coating, a suitable amount of tungsten trioxide is required in the formulation of the film-forming composition. According to a preferred embodiment of the present invention, the tungsten trioxide is present in an amount ranging from 0.1% by weight to 20% by weight of the total composition. The tungsten trioxide used is preferably in the form of finely ground particles and does not result in any haze nor turbidity. When the amount of tungsten trioxide used in the composition is more than the preferred range, the visible light transmittance of the formed near-infrared shielding coating may be reduced, thereby reducing transparency thereof.

To maintain appreciable visible light transmittance and transparency of the formed coating while providing substantial near-infrared shielding/absorbing functionality, the particle size of the tungsten trioxide used may preferably be less than the wavelength of visible light. A preferred embodiment of the present invention describes that the tungsten trioxide used has a particle size of less than 500 nm. To acquire workability when mixing the tungsten trioxide into the film-forming binder, it is preferable that the tungsten trioxide is uniformly dispersed in the form of nanoparticles in a solvent. It has been confirmed that the tungsten trioxide nanoparticle dispersion is highly transparent in the near-infrared region and able to exhibit near-infrared shielding and absorption within the range of wavelengths between 800 nm to 1000 nm. The shielding and absorption of near-infrared radiation may be due to scattered transmitted radiation being collected in the integrating spheres of the tungsten trioxide nanoparticles. A solvent is basically used to disperse the tungsten trioxide. According to a preferred embodiment of the present invention, the solvent used for dispersing the tungsten trioxide is selected from water, alcoholic solvents, ketone ether solvents and solvents having two or more functional groups selected from the group consisting of diethylene glycol diethyl ether, propylene glycol monoethyl ether acetate and dipropylene glycol monomethyl ether propanol. Examples of the aforementioned propylene glycol monoethyl ether acetate may include 1-ethoxy-2-propylacetate and 2-ethoxy-1-propylacetate whereby the mixture of 2-propyl- and 1-propylacetates in a ratio of 90% or more than 10% or less. Solvents of high polarity such as the dipropylene glycol monomethyl ether propanol may be preferably used, but not limited to (2-methoxymethylethoxy) dimethylformamide or N-methylpyrrolidone. In addition, the solvents are also provided to improve the solubility of additives.

Additives may be used in formulating the film-forming composition for producing the near-infrared shielding coating so as to improve properties, appearance and stability thereof. Accordingly, the film-forming composition of the present invention further comprises a mixture of additives selected from an ultraviolet-absorbing agent, an infrared-reflecting agent or infrared-absorbing agent, a dye and/or pigment, a stabilizing agent and a photo-stabilizing agent.

A wide range of ultraviolet-absorbing agents may be used in the film-forming composition. For instance, when alkali-repellency is required in the case of film tearing off by alkaline reagents, alkali-soluble ultraviolet-absorbing agents may be selected from benzophenone-type or benzotriazole-type. Examples of benzophenone-type ultraviolet-absorbing agents include 2-hydroxy-4-methoxy-benzophenone, 2,4-dihydroxy-benzophenone, 2,2′,4,4′-tetrahydroxybenzophenone, 2-hydroxy-4-methoxybenzophenone-5-sulfonic acid.

An infrared-screening agent is used in the film-forming composition to impart protective properties against infrared radiation into the near-infrared shielding coating. In the present invention, there are two types of infrared-screening agent used, namely infrared-reflecting and infrared-absorbing types. Examples of infrared-reflecting type agents may include perylene black pigments manufactured by BASF. Examples of infrared-absorbing type agents may include organic pigments such as aniline or polyaniline type manufactured by Nippon Carlit Co., Ltd., cyanine or phthalocyanine type manufactured by Nippon Shokubai Co., Ltd., and inorganic compounds such as zinc oxide, indium tin oxide and antimony tin oxide, or metal complexes such as copper, silver, iron and manganese which are manufactured by Kureha Chemical Co., Ltd., and effective in the wavelength range from 600 nm.

In the context of the present invention, the ultraviolet-absorbing agent and infrared-screening agent used in the present invention as the additive may present in an amount from 1 to 45% by weight of the film-forming composition. If the ultraviolet-absorbing agent and infrared-screening agent is less than 1% by weight, the ultraviolet-absorbing effect becomes weak and the film repellency is decreased. On the other hand, an amount thereof more than 45% by weight not only decreases the water and chemical resistance but causes a blooming or bronzing phenomenon. Thus, a preferable amount of 1.5 to 20% by weight is desirable from a viewpoint of practice.

The mixture of additives used in the film-forming composition of the present invention preferably comprises dyes and/or pigments having high weather resistance. Examples of acceptable dyes include a direct dye such as CI Direct Yellow 98, CI Direct Red 220 and CI Direct Blue 77, and an acid dye such as CI Acid Yellow 112, CI Acid Red 256 and CI Acid Blue 182. Some examples of acceptable pigments may also include an inorganic pigment such as CI Pigment Yellow 157, CI Pigment Red 101 and CI Pigment Blue 29 and an organic pigment such as CI Pigment Yellow 154, CI Pigment Red 122 and CI Pigment Blue 15:1. Depending on preferences, the dyes and pigments may be used independently or in combination.

If desired, special pigments to enhance appearances may also be used. Examples of special pigments may include fluorescent pigments for assuming fluorescent colours such as Acid Yellow 73 dissolved in an acrylic resin, luminescent pigments such as strontium aluminate which continuously glow after ceasing irradiation, pearlescent pigments such as mica coated with titanium dioxide for assuming a pearl effect, thermo-color pigments such as microcapsulated Rhodamine B lactam/isooctyl gallate/cetyl alcohol which change color depending on the temperature, hydrophilic pigments such as silica and titania for providing hydrophilic properties, special pigments to adjust the light transmittance such as carbon black and functional pigments which reflect infrared light or heat rays.

In the film-forming composition of the present invention, it is preferable to include an additive of a stabilizing agent for stabilizing an off electron pair of a nitrogen atom, which would normally be derived from the alkoxysilane having an amino group with an active hydrogen which would otherwise cause an unwanted reaction with the ultraviolet-absorbing agent, infrared-screening agent, dye and pigments. For example, preferable stabilizing agents may include salicylic acid, fumaric acid, crotonic acid, succinic acid, tararic acid, p-hydroxy-benzoic acid, pyrogallol, resorcinol or combinations thereof.

A photo-stabilizing agent may also be used in the mixture of additives in the formulation of the film-forming composition. Examples of photo-stabilizing agent used in the mixture of additives include [2,2′-Thiobis(4-tert-octylphenolate)]-2-ethylhexylamine nickel (trade name of Viosorb; molecular weight: 635), nickel dibutyl dithiocarbamate (trade name of Antigene NBC; molecular weight: 407) and [N-acetyl-3-dodecyl-1 (2,2,6,6-tetramethyl-4-piperidinyl) pyrolidone-2,5-dione (tradename of Sanduvor 3058).

An exemplary embodiment of the present invention also describes a method for producing a near-infrared shielding coating using the abovementioned film-forming composition. As aforementioned, a film-forming binder comprising a reaction product of an alkoxysilane having an epoxy group and an alkoxysilane having an amino group with an active hydrogen with silane compounds such as tri- or dialkoxysilane, monoalkoxysilane, and/or glycidesilane is prepared. The step is followed by preparation of a dispersion of a near-infrared shielding material in a solvent so that a nanoparticle dispersion can be mixed with the film-forming binder. In the context of the present invention, the near-infrared shielding material may be selected from the group consisting of tungsten trioxide, antimony tin oxide, indium tin oxide, stanum oxide and stanum dioxide. More preferably, tungsten trioxide is used. Prior to mixing of the film-forming binder with the tungsten trioxide nanoparticle dispersion, a mixture of additives as abovementioned is added thereinto in the presence of an acid catalyst. A resultant liquid mixture ready for application on a substrate is obtained.

It is crucial to remove dirt of oil, wax or the like on the surface of the substrate such as glass before application of the liquid mixture. Although there are various conventional manners for removing an oil film, an oil film stripping compound is used in a desirable manner. The film-forming composition of the present invention may be applied on the substrate by means of a brush, felt, non-woven fabric, spray gun or any other suitable means. It is desirable to apply the film-forming composition in the direction of gravity so that non-uniformity of the coating seldomly results. Once applied, the film-forming composition is cured on the substrate to form the near-infrared shielding coating. The film-forming composition may be cured at room temperature to form a hard film of dry to touch hardness within 0.5 to 12 hour and then yields a beautiful, transparent and solid cured coating having a pencil hardness of 1H to 5H or more after drying for 12 to 24 hours.

### EXAMPLE

The following non-limiting example has been carried out to illustrate the preferred embodiments of the invention.

### Example 1

(1) 3-Glycidoxypropyltrimethoxysilane in an amount of 33.35 g and 16.67 g of 3-Aminopropyltriethoxysilane were mixed, stirred for one hour and then allowed to be cured in a constant room temperature at 25° C. for 14 days for aging to yield a reaction product.
(2) In 35 g of dipropylene glycol monomethyl ether acetate, 15 g of tungsten trioxide having a particle size of 10 nm is dispersed.
(3) Mixtures in step (1) and (2) were mixed in a ratio of 1:1 and stirred homogenously for 1 minute to produce a transparent film-forming composition (I).
(4) The composition (I) produced in step (3) was applied on a piece of glass substrate having a thickness of 6 mm.
(5) The coated glass substrate was dried at a room temperature at 25° C. and a relative humidity of 40%.

### Control Example 1

A control sample of a transparent film-forming composition (I′) was prepared in a similar manner as described in Example 1 except that a dispersion of step (2) was not added therein. The control composition (I′) produced was applied on a piece of glass substrate having a thickness of 6 mm. The coated glass substrate was dried at a room temperature at 25° C. and a relative humidity of 40%.

### Example 2

(6) 3-Glycidoxypropyltrimethoxysilane in an amount of 18.57 g, 20.00 g of 3-Aminopropyltriethoxysilane and 11.43 g of methyltrimethoxysilane were mixed, stirred for one hour and then allowed to be cured in a constant room temperature at 25° C. for 14 days for aging to yield a reaction product.
(7) A tungsten trioxide dispersion similar to step (2) was prepared in a similar manner as described in Example 1.
(8) Mixtures in step (6) and (7) were mixed in a ratio of 1:1 and stirred homogenously for 1 minute to produce a transparent film-forming composition (II).
(9) The composition (II) produced in step (8) was applied on a piece of glass substrate having a thickness of 6 mm.
(10) The coated glass substrate was dried at a room temperature at 25° C. and a relative humidity of 40%.

### Control Example 2

A control sample of a transparent film-forming composition (II′) was prepared in a similar manner as described in Example 2 except that a dispersion of step (7) was not added therein. The control composition (II′) produced was applied on a piece of glass substrate having a thickness of 6 mm. The coated glass substrate was dried at a room temperature at 25° C. and a relative humidity of 40%.

### Example 3

(11) 3-Glycidoxypropyltrimethoxysilane in an amount of 30.88 g, 17.23 g of 3-Aminopropyltriethoxysilane and 1.91 g of methyltrimethoxysilane were mixed, stirred for one hour and then allowed to be cured in a constant room temperature at 25° C. for 14 days for aging to yield a reaction product.
(12) A tungsten trioxide dispersion similar to step (2) was prepared in a similar manner as described in Example 1.
(13) Mixtures in step (11) and (12) were mixed in a ratio of 1:1 and stirred homogenously for 1 minute to produce a transparent film-forming composition (III).
(14) The composition (III) produced in step (13) was applied on a piece of glass substrate having a thickness of 6 mm.
(15) The coated glass substrate was dried at a room temperature at 25° C. and a relative humidity of 40%.

### Control Example 3

A control sample of a transparent film-forming composition (III′) was prepared in a similar manner as described in Example 3 except that a dispersion of step (12) was not added therein. The control composition (III′) produced was applied on a piece of glass substrate having a thickness of 6 mm. The coated glass substrate was dried at a room temperature at 25° C. and a relative humidity of 40%.

### Example 4

(16) 3-Glycidoxypropyltrimethoxysilane in an amount of 25.82 g and 24.19 g of 3-Aminopropyltriethoxysilane were mixed, stirred for one hour and then allowed to be cured in a constant room temperature at 25° C. for 14 days for aging to yield a reaction product.
(17) A tungsten trioxide dispersion similar to step (2) was prepared in a similar manner as described in Example 1.
(18) Mixtures in step (16) and (17) were mixed in a ratio of 1:1 and stirred homogenously for 1 minute to produce a transparent film-forming composition (IV).
(19) The composition (IV) produced in step (18) was applied on a piece of glass substrate having a thickness of 6 mm.
(20) The coated glass substrate was dried at a room temperature at 25° C. and a relative humidity of 40%.

### Control Example 4

A control sample of a transparent film-forming composition (IV′) was prepared in a similar manner as described in Example 4 except that a dispersion of step (17) was not added therein. The control composition (IV′) produced was applied on a piece of glass substrate having a thickness of 6 mm. The coated glass substrate was dried at a room temperature at 25° C. and a relative humidity of 40%.

Composition of the products abovementioned is shown in details in Table 1 below.

TABLE 1

| | Component | | | | |
|---|---|---|---|---|---|
| Composition | A | B | C | D | E |
| Example 1 | 33.35 | 16.67 | 0 | 35 | 15 |
| Control 1 | 33.35 | 16.67 | 0 | 35 | 0 |
| Example 2 | 18.57 | 20 | 11.43 | 35 | 15 |
| Control 2 | 18.57 | 20 | 11.43 | 35 | 0 |
| Example 3 | 30.88 | 17.23 | 1.91 | 35 | 15 |
| Control 3 | 30.88 | 17.23 | 1.91 | 35 | 0 |
| Example 4 | 25.82 | 24.19 | 0 | 35 | 15 |
| Control 4 | 25.82 | 24.19 | 0 | 35 | 0 |

A: 3-Glycidoxypropyltrimethoxysilane
B: 3-Aminopropyltriethoxysilane
C: Methyltrimethoxysilane
D: Dipropylene glycol monomethyl ether acetate
E: Tungsten trioxide

Using the transparent film-forming compositions prepared in the Examples and Control examples, application on a glass substrate and curing of the thus formed coatings will be detailed in the following.

### Oil Film Removal Process

An oil film cleaning compound is spread on an abrasive sponge containing a small amount of water to scour all over the surface of a glass substrate. The glass substrate is wiped with the sponge thoroughly to confirm that the oil film on the glass substrate is completely removed. When water droplets do not appear on the glass substrate contaminated with the oil film, the aforementioned cleaning procedure is repeated using the oil film cleaning compound until the surface of the glass substrate gets wet all over. Water and the cleaning compound are then wiped off completely while the surface of the glass substrate is further cleaned with a non-woven fabric of several folds and isopropyl alcohol to remove the oil.

### Application Process of Transparent Film-Forming Compositions

About 30 ml of a solution of the transparent film-forming compositions prepared as abovementioned in the Examples is poured into a 150 ml tray and soaked into only an oblique section of a melamine foam sponge. While holding the sponge tight, the thus soaked solution is applied slowly onto the surface of the glass substrate from the right or left top to the bottom in the direction of gravity to form a belt-like coating. Upon reaching the bottom of the glass substrate, a similar procedure is repeated from the top to the bottom in the direction of gravity, thereby overlapping about one third to one fourth of each application until the glass substrate is coated homogenously as a whole.

### Drying Process

Upon completion of the application, the coated glass substrate is kept in a suitable area without the influence of moisture and dust, particularly at a room temperature of about ° C. and a humidity of 40% to proceed by air drying for about 10 minutes. Generally, the coated film is dry to the touch when the coated surface of the glass substrate does not stick to the fingers. The coated film that is almost completely dried up is allowed to be cured for about 24 hours so that the film formed on the surface of the glass substrate, such as a window, is not scratched through by handling with a soft cloth.

Various film properties of the film-forming compositions as prepared in the abovementioned were evaluated and discussed below.

### Dry To The Touch Time

Dry to the touch time was determined according to a method based on Japanese Industrial Standards (JIS) K 5400 at 10 minutes intervals at 25° C.

Conditions of the coated films at the time of 72 hours after application was evaluated in the following:

### Transparency

The coated film was visually evaluated based on KIS K 5400.

### Hardness of Film

The hardness of the coated film was evaluated according to the pencil scratch test based on JIS K 5400.

### Ultraviolet (UV) Transmittance

The transparent film-forming compositions prepared as abovementioned in the Examples were applied on glass test pieces (70 mm in width×110 mm in length×5 mm in thickness) and dried in a similar manner as described above. Each test piece was evaluated by determining the ultraviolet transmittance in a wavelength of 345 nm based on ISO 9050 by means of a spectrophotometer. The ultraviolet transmittance was further determined at the time of 192 hours after the test pieces were kept in an accelerated light resistance testing device specified by JIS B 7754.

### Infrared (IR) Transmittance

The infrared transmittance was determined according to a method based on ISO 9050:2003 by means of a spectrophotometer (Shimazu Double Chronometer).

### Visible Light (Vis) Transmittance

The visible light transmittance was determined according to a method ISO 9050:2003 by means of a spectrophotometer (Shimazu Double Chronometer).

### Solar Heat Gain Coefficient

The solar heat gain coefficient was determined according to Window Energy Profiler Model 4500 by EDTM.

With regard to the Examples and Control Examples, the film properties of each film-forming composition are shown in Table 2 below.

TABLE 2

| | Drying | Transmittance | | | Hardness | | |
|---|---|---|---|---|---|---|---|
| | Time | (%) | | | After | | Solar Heat |
| | (hours) | UV | IR | Vis | 24 Hours | | Gain Coefficient |
| Example 1 | 12 | 49 | 8 | 72 | 1 | H | 0.42 |
| Control 1 | 20 | 59 | 68 | 89 | HB | | 0.83 |
| Example 2 | 0.5 | 49 | 4 | 70 | 5 | H | 0.38 |
| Control 2 | 1 | 63 | 71 | 89 | 3 | H | 0.84 |
| Example 3 | 0.5 | 49 | 3 | 69 | 4 | H | 0.35 |
| Control 3 | 4 | 62 | 70 | 90 | 2 | H | 0.85 |
| Example 4 | 0.5 | 63 | 5 | 72 | 5 | H | 0.41 |
| Control 4 | 2 | 50 | 71 | 89 | 4 | H | 0.83 |

The transparent film-forming compositions of the present invention as provided in Table 1 and 2 do not cause insufficient coating and is curable at room temperature of about 25° C. within a short period of time, thereby producing an attractive and weather-resistant film having a film hardness of 1H to 5H after the film is cured by air drying. Further, the composition of the present invention comprising an essential component of a near-infrared shielding material, particularly of tungsten trioxide, makes it possible to shield and absorb near-infrared radiation within the region of wavelengths between 800 nm to 1000 nm.

The present disclosure includes as contained in the appended claims, as well as that of the foregoing description. Although this invention has been described in its preferred form with a degree of particularly, it is understood that the present disclosure of the preferred form has been made only by way of example and that numerous changes in the details of construction and the combination and arrangements of parts may be resorted to without departing from the scope of the invention.

1.-16. (canceled)

17. A transparent film-forming composition for producing a near-infrared shielding coating, comprising:
a film-forming binder comprising a primary component of a reaction product of an alkoxysilane having an epoxy group and an alkoxysilane having an amino group with an active hydrogen;
an acid catalyst; and
a near-infrared shielding material.

18. The composition according to claim 17, wherein the near-infrared shielding material used is selected from the group consisting of tungsten trioxide, antimony tin oxide, indium tin oxide, stanum oxide and stanum dioxide.

19. The composition according to claim 17, wherein the near-infrared shielding material used is tungsten trioxide.

20. The composition according to claim 19, wherein the tungsten trioxide is present in an amount ranging from 0.1% by weight to 20% by weight of the total composition.

21. The composition according to claim 20, wherein the tungsten trioxide has a particle size of less than 50 nm.

22. The composition according to claim 21, wherein the tungsten trioxide is uniformly dispersed in the form of nanoparticles in a solvent.

23. The composition according to claim 22, wherein the solvent used for dispersing the tungsten trioxide is selected from water, alcoholic solvents, ketone ether solvents and solvents having two or more functional groups selected from the group consisting of diethylene glycol diethyl ether, propylene glycol monoethyl ether acetate and dipropylene glycol monomethyl ether propanol.

24. The composition according to claim 17, wherein the film-forming binder further comprises a secondary component of silane compounds selected from tri- or dialkoxysilane, monoalkoxysilane, glycidesilane or combinations of any two or more thereof.

25. The composition according to claim 17, further comprising a mixture of additives selected from an ultraviolet-absorbing agent, an infrared-reflecting agent or infrared-absorbing agent, a dye and/or pigment, a stabilizing agent and a photo-stabilizing agent.

26. The composition according to claim 17, wherein the acid catalyst is selected from sulphuric acid, nitric acid, organophosphorus compounds and p-toluenesulfonic acid.

27. A near-infrared shielding coating, comprising:
a film-forming binder comprising a reaction product of an alkoxysilane having an epoxy group and an alkoxysilane having an amino group with an active hydrogen with tri- or dialkoxysilane, monoalkoxysilane, and/or glycidesilane;
an acid catalyst; and
a near-infrared shielding material.

28. The near-infrared shielding coating according to claim 27, wherein the near-infrared shielding material is selected from the group consisting of tungsten trioxide, antimony tin oxide, indium tin oxide, stanum oxide and stanum dioxide.

29. The near-infrared shielding coating according to claim 28, wherein the near-infrared shielding material used is tungsten trioxide.

30. A method for producing a near-infrared shielding coating, comprising the steps of:
preparing a film-forming binder comprising a reaction product of an alkoxysilane having an epoxy group and an alkoxysilane having an amino group with an active hydrogen with tri- or dialkoxysilane, monoalkoxysilane, and/or glycidesilane;
preparing a dispersion of a near-infrared shielding material by dispersing thereof in a solvent, followed by addition of a mixture of additives thereinto;
mixing the film-forming binder with the dispersion in the presence of an acid catalyst to form a transparent film-forming composition;
applying the film-forming composition on a pre-treated surface of a substrate; and
curing the film-forming composition to form the near-infrared shielding coating.

31. The method according to claim 30, wherein the near-infrared shielding material is selected from the group consisting of tungsten trioxide, antimony tin oxide, indium tin oxide, stanum oxide and stanum dioxide.

32. The method according to claim 31, wherein the near-infrared shielding material used is tungsten trioxide.
